(19) United States
(12) Patent Application Publication
(10) Pub. No.: US 2007/0188504 A1
(43) Pub. Date: Aug. 16, 2007

(54) Random-text display lighter

(76) Inventor: Daniel L. Lewis, VA. Beach, VA (US)

Correspondence Address: MENDELSOHN AND ASSOCIATES, P.C., 1500 JOHN F. KENNEDY BLVD., SUTIE 405, PHILADELPHIA, PA, 19102, US

(21) Appl. No.: 11/707,495

(22) Filed: Feb. 16, 2007

Related U.S. Application Data
(60) Provisional application No. 60/773,595, filed on Feb. 16, 2006.

(51) Int. Cl. G06T 1/00

(52) U.S. Cl. 345/501

(57) ABSTRACT

A lighter including, in one embodiment, a housing, a fuel tank disposed within the housing, a valve adapted to release fuel from the fuel tank, a piezoelectric unit adapted to provide a spark to ignite fuel released from the fuel tank, a display, circuitry, and an activator. The circuitry includes one or more random-number generators, each random-number generator adapted to provide a random number from among a plurality of possible numbers. The circuitry further includes one or more look-up tables, each look-up table mapping each of the plurality of possible numbers from one of the random-number generators to a corresponding alphanumeric phrase. The circuitry is adapted to (i) generate a random number using one of the random-number generators, (ii) retrieve, from the one or more look-up tables, an alphanumeric phrase corresponding to the generated random number, and (iii) display the retrieved alphanumeric phrase on the display. The activator is adapted to (i) engage the piezoelectric unit to provide a spark, (ii) engage the valve to release fuel from the fuel tank, and (iii) engage the circuitry to display at least one retrieved alphanumeric phrase on the display.

### CROSS-REFERENCE TO RELATED APPLICATIONS

This application claims the benefit of the filing date of U.S. provisional application No. 60/773,595, filed on Feb. 16, 2006, the teachings of which are incorporated herein by reference.

### BACKGROUND OF THE INVENTION

1. Field of the Invention

The present invention relates to lighters, and more particularly, to cigarette lighters that display one or more numeric or text phrases randomly selected from a plurality of predetermined phrases.

2. Description of the Related Art

Conventional gas lighters are flame-producing devices that are commonly used to light cigarettes, cigars, and pipes, although they may be used as ignition sources to light candles, gas burners, stoves, and other light-producing or heat-producing devices. In a gas lighter, a spark ignites a stream of gas, such as butane, isobutane, propane, or other liquefied hydrocarbon stored as a liquid under pressure. The spark used to ignite the gas is created either mechanically, such as by a user rapidly rotating a thumbwheel against which a flint is biased, or electronically, such as by striking a piezoceramic element with sufficient force to generate an electric potential high enough to create the spark.

Novelty gas lighters of varying types have been proposed, including gas lighters that display various images and indicators to a user.

For example, U.S. Pat. No. 3,816,057 to Semenko discloses a gas lighter that contains a film-strip loop that advances sequentially through a plurality of advertisements or informational pictures each time the lighter is activated.

U.S. Pat. No. 4,094,140 to Ohue et al., U.S. Pat. No. 6,693,850 to Mulaw, and U.S. Design Pat. No. D439,370 to Chen all disclose gas lighters having an integral LCD or LED clock display.

U.S. Pat. No. 4,311,448 to Strauss discloses a gas lighter having an integral smoking-elimination guidance system that indicates on an LCD display, at progressively longer intervals, when the user should smoke the next cigarette.

U.S. Design Pat. No. D475,481 to Xu discloses a gas lighter having a integral glass tube thermometer to display ambient temperature.

U.S. Pat. No. 5,090,892 to Chuang discloses a gas lighter having a rotating disk driven by a gear that turns when the lighter is activated. A plurality of lamps are disposed around the disk, such that, as the disk rotates, an electrical connection is made with one of the lamps at a time, in sequence, to illuminate the lamps in roulette-wheel fashion, in a rotating pattern. Eventually, only one of the lamps remains illuminated, depending on the final resting position of the disk when the disk ceases to rotate. Music or a buzzer can also sound when the lighter is activated.

U.S. Pat. No. 5,067,895 to Chuang et al. discloses a holder casing for a gas lighter. The holder casing includes a plurality of lamps driven by a flash driver circuit that causes the lamps to flash when the lighter is activated. Music or a buzzer can also sound when the lighter is activated.

U.S. Pat. No. 4,948,361 to Wu discloses a gas lighter having a slot machine-style lever that is used both to activate the lighter and to mechanically drive the rotation of a plurality of reels having slot-machine reel indicia to simulate a miniature slot machine.

### SUMMARY OF THE INVENTION

In one embodiment, the present invention provides a lighter including a housing, a fuel tank disposed within the housing, a valve adapted to release fuel from the fuel tank, a piezoelectric unit adapted to provide a spark to ignite fuel released from the fuel tank, a display, circuitry, and an activator. The circuitry includes one or more random-number generators, each random-number generator adapted to provide a random number from among a plurality of possible numbers. The circuitry further includes one or more look-up tables, each look-up table mapping each of the plurality of possible numbers from one of the random-number generators to a corresponding alphanumeric phrase. The circuitry is adapted to (i) generate a random number using one of the random-number generators, (ii) retrieve, from the one or more look-up tables, an alphanumeric phrase corresponding to the generated random number, and (iii) display the retrieved alphanumeric phrase on the display. The activator is adapted to (i) engage the piezoelectric unit to provide a spark, (ii) engage the valve to release fuel from the fuel tank, and (iii) engage the circuitry to display at least one retrieved alphanumeric phrase on the display.

In another embodiment, the present invention provides a method of providing a flame and displaying one or more alphanumeric phrases. The method includes: (a) engaging a piezoelectric unit to provide a spark; (b) releasing fuel from a fuel tank; and (c) engaging circuitry adapted to: (i) generate a random number from among a plurality of possible numbers and (ii) retrieve, from a look-up table, an alphanumeric phrase corresponding to the generated random number; and (iii) display the retrieved alphanumeric phrase on a display.

In a further embodiment, the present invention provides an apparatus including: a lighter, circuitry, and an activator. The circuitry includes (a) one or more random-number generators, each random-number generator adapted to provide a random number from among a plurality of possible numbers, and (b) one or more look-up tables, each look-up table mapping each of the plurality of possible numbers from one of the random-number generators to a corresponding alphanumeric phrase. The circuitry is adapted to: (i) generate a random number using one of the random-number generators, (ii) retrieve, from the one or more look-up tables, an alphanumeric phrase corresponding to the generated random number, and (iii) display the retrieved alphanumeric phrase on the display. The activator is adapted to: (i) engage the lighter to provide a flame; and (ii) engage the circuitry to display at least one retrieved alphanumeric phrase on the display.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a front elevational view of a random-text display lighter consistent with one embodiment of the invention;

FIG. 2 is a rear elevational view of the random-text display lighter of FIG. 1;

FIG. 3 is a bottom side view of the random-text display lighter of FIG. 1;

FIG. 4 is a plan view of the random-text display lighter of FIG. 1;

FIG. 5 is a left-side view of the random-text display lighter of FIG. 1;

FIG. 6 is a right-side view of the random-text display lighter of FIG. 1;

FIG. 7 is a front sectional view of the random-text display lighter of FIG. 1;

FIG. 8 is a front exploded view of the random-text display lighter of FIG. 1, including a front perspective sectional view of the piezoelectric unit;

FIG. 9 is a block diagram of an exemplary display module of the random-text display lighter of FIG. 1;

FIG. 10 illustrates the contents of an exemplary look-up table in the random-text display lighter of FIG. 1, in a lottery number-generating embodiment;

FIG. 11 illustrates the contents of an exemplary look-up table in the random-text display lighter of FIG. 1, in a keno number-generating embodiment;

FIG. 12 illustrates the contents of an exemplary look-up table in the random-text display lighter of FIG. 1, in a roulette text-and-number-generating embodiment;

FIG. 13 illustrates the contents of an exemplary look-up table in the random-text display lighter of FIG. 1, in a fortune-teller text-generating embodiment;

FIG. 14 illustrates the contents of exemplary look-up tables in the random-text display lighter of FIG. 1, in a bingo text-and-number-generating embodiment;

FIG. 15 illustrates the contents of exemplary look-up tables in the random-text display lighter of FIG. 1, in a horse-race text-generating embodiment; and

FIG. 16 illustrates a flow chart for an exemplary sequence of operation of the random-text display lighter of FIG. 1.

### DETAILED DESCRIPTION

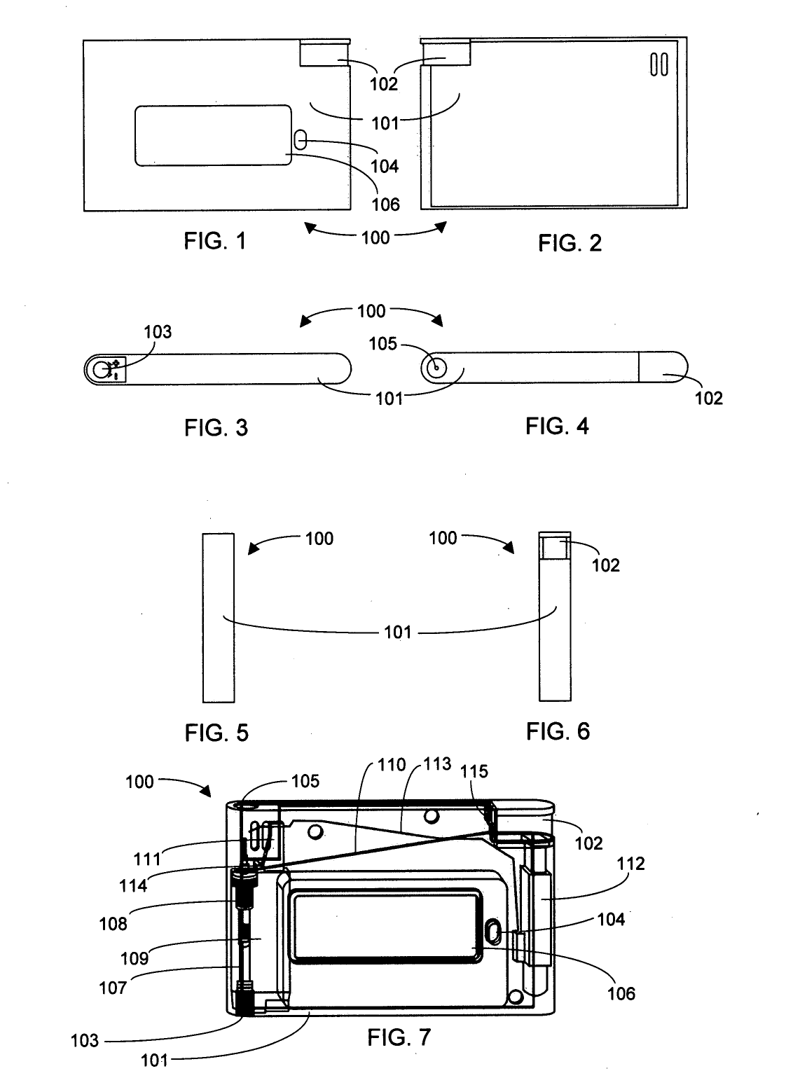

With reference to FIGS. 1-6, the external features of a random-text display lighter 100 consistent with one exemplary embodiment of the present invention are illustrated. As shown, lighter 100 includes a housing 101, a plunger button 102 (or other activator), an air inlet 103, a switch 104, a flame port 105, and a display 106. To use random-text display lighter 100, a user depresses plunger button 102, which causes a flame to exit via flame port 105 and further causes one or more alphanumeric characters to be displayed on display 106. Alternatively, the user can depress switch 104 to cause the alphanumeric characters to be displayed on display 106 without activating the flame functionality.

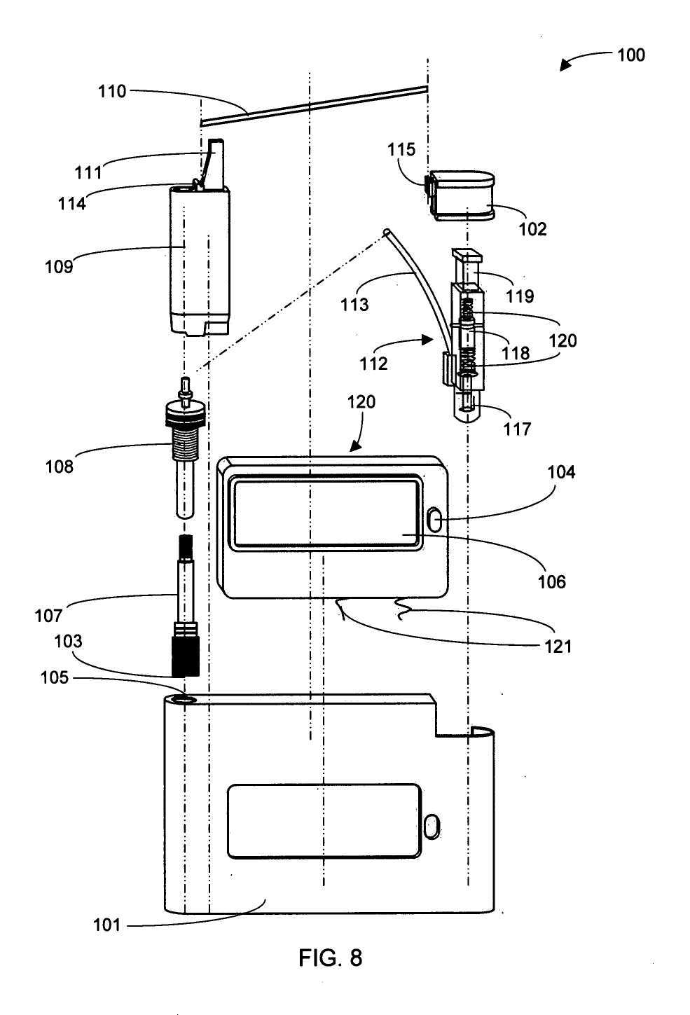

Turning now to FIGS. 7 and 8, the internal structure and operation of random-text display lighter 100 will now be described. Lighter 100 further includes an air-inlet assembly 107, an air-outlet assembly 108, a fuel tank 109, an activation lever 110, a fuel-tank release valve 111, a piezoelectric unit 112, ignition wiring 113, engagement portions 114 and 115, a display module 120, and wiring 121.

Air-inlet assembly 107 draws in external air via air inlet 103. As best seen in FIG. 3, air-inlet assembly 107 is desirably adjustable to permit varying the amount of air flowing through air inlet 103, thereby permitting flame-size control.

Air-outlet assembly 108 receives gaseous fuel from fuel tank 109 and air from air-inlet assembly 107. The gaseous fuel is mixed with the air, and the gaseous fuel/air mixture is combusted to generate a pre-mixed flame, which exits from lighter 100 via flame port 105. The pre-mixed flame is the product of a combustion process wherein the gaseous fuel is mixed with the air in near stoichiometric proportions and proceeds to nearly-complete reaction upon ignition. Due to the nearly-complete combustion reaction, the process produces substantially no soot or uncombusted fuel, nor products of incomplete combustion. Also, since the fuel is pre-mixed with air, the flame is not dependent upon the orientation of the lighter and is able to burn within an enclosed space.

Fuel tank 109 contains a combustible fluid, such as butane, which is released when fuel-tank release valve 111 is raised.

One end of activation lever 110 engages engagement portion 114 of fuel-tank release valve 111, and the other end of activation lever 110 engages engagement portion 115 of plunger button 102. At a point (not shown) near its mid-section, activation lever 110 is mounted and rotatably disposed within housing 101 in seesaw fashion, such that depressing plunger button 102 causes activation lever to raise fuel-tank release valve, thereby initiating the flow of gas from fuel tank 109 into air-outlet assembly 108.

As best seen in FIG. 8, piezoelectric unit 112 includes piezoceramic cylinder 117, ironwork 118, plunger 119, and ignition springs 120. When plunger button 102 is depressed, plunger 119 and ironwork 118, which are slidably disposed within piezoelectric unit 112, travel downward and cause mechanical pressure to be applied to piezoceramic cylinder 117, which is, e.g., a pre-stressed ceramic piezoelectric element. The pressure load generates an electric potential of several kilovolts, which is carried by ignition wiring 113.

The current carried along ignition wiring 113 is used to generate one or more sparks in a spark gap at the other end of ignition wiring 113, adjacent to flame port 105. The sparks ignite the gas/fuel mixture, and the resulting flame exits via flame port 105. Ignition springs 120 bias plunger 119 and ironwork 118 away from piezoceramic cylinder 117 and toward plunger button 102. Piezoelectric unit 112 also desirably includes a child-safety spring (not shown) to increase the force necessary to activate the flame functionality.

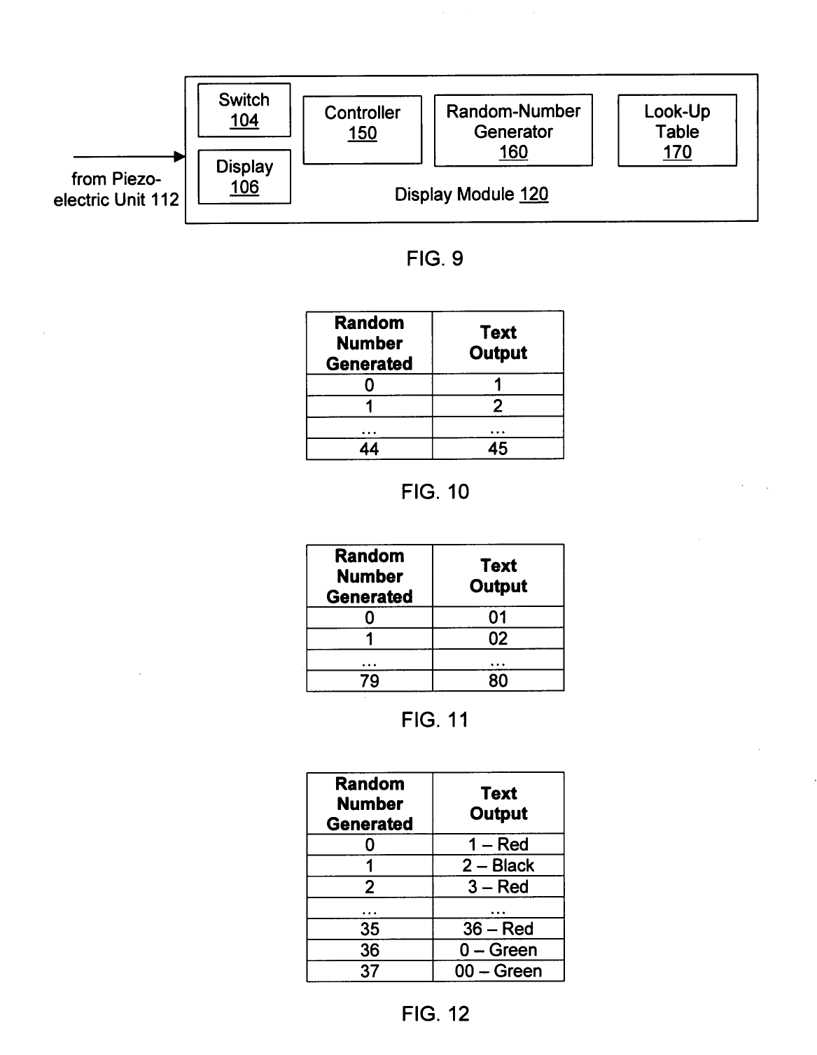

Now turning to FIG. 9, a block diagram of display module 120, which enables the text-display functionality of lighter 100, is shown. Display module 120 includes switch 104 and display 106 and further includes a controller 150, a random-number generator 160, and a look-up table 170.

Power for display module 120 can be provided by a battery (not shown) or, alternatively, by harvesting power from the striking of piezoceramic cylinder 117 by ironwork 118 within piezoelectric unit 112. Such power harvesting can generate electrical charges, which, in various embodiments of the invention (i) directly drive display module 120 and/or (ii) recharge a battery that drives display module 120. Display module 120 is configured to initiate a random-number generation and numeric or alphanumeric look-up process upon depression of plunger button 102 and/or activation of switch 104. Accordingly, display module 120 is electrically coupled to piezoelectric unit 112 via suitable wiring 121 (e.g., by connection to ignition wiring 113) to receive (i) one or more electrical signals to activate display module 120 and/or (ii) an electrical current to drive display module 120.

Switch 104 is a momentary contact switch that can be depressed to initiate the random-number generation and numeric or alphanumeric look-up process without activating the flame function. To activate both the flame function and the random-number generation and numeric or alphanumeric look-up process, a user can instead depress plunger button 102.

Display 106 is a numeric or alphanumeric display unit and may include a liquid-crystal display (LCD), a segmented light-emitting diode (LED) display, or other numeric or alphanumeric visual indicator. Depending on the length and number of the numeric and/or text phrases to be displayed, display 106 may be of varying character width and may include scroll functionality to scroll one or more phrases collectively having a character width exceeding the character width of display 106, thereby permitting a viewer to view the entire message. In alternative embodiments, such scrolling may include scrolling to the left, scrolling both left and right, scrolling up, scrolling up-and-down, and flashingly or alternatingly displaying phrases or portions thereof.

Controller 150 monitors for an event, e.g., the depression of plunger button 102 and/or activation of switch 104, to start the random-number generation and numeric or alphanumeric look-up process. Once such an event has been detected, controller 150 activates random-number generator 160.

Random-number generator 160 is adapted to generate a random number upon activation by controller 150. The random number may be an integer selected from among a range of integers (e.g., 0 to 44), or alternatively, may be a non-integer (e.g., a 2-digit decimal number between 0 and 1). In alternative embodiments, a plurality of separate random-number generators may be provided, so that multiple random numbers can be generated in parallel. Alternatively, a single random-number generator may be used a plurality of times upon a single activation by controller 150 to generate a plurality of random numbers. The term “random” in the context of selection or number generation, as used herein, should not be construed as limited to pure random selections or number generations, but should be understood to include pseudo-random, including seed-based selections or number generations, as well as other selection or number generation methods that might simulate randomness but are not actually random, or do not even attempt to simulate randomness.

Look-up table 170 is desirably a non-volatile memory device that maps each different random number that random-number generator 160 could possibly generate to a respective numeric or alphanumeric phrase. This permits a sequence of one or more numeric or alphanumeric phrases to be generated, either in series or in parallel, for presentation on display 106, e.g., as a sequence of phrases. In alternative embodiments, multiple look-up tables can be used, either to determine the corresponding numeric or alphanumeric phrases of the same type for a plurality of numbers in parallel, or to determine the corresponding numeric or alphanumeric phrases of different types for different numbers, as will be described in further detail with reference to the examples of FIGS. 10-15, all of which map integers between 0 and N generated by random-number generator 160 to various numeric or alphanumeric phrases.

FIG. 10 shows an exemplary numeric look-up table for use in generating lottery numbers. In this example, a player buying a lottery ticket must provide six numbers between 1 and 45, and lighter 100 can be used to generate a selection for the player using six look-up instances, displaying on display 106 a sequence such as “4 8 15 16 23 42.”

FIG. 11 shows an exemplary numeric look-up table for use in generating keno numbers. In this example, a player buying a keno ticket must provide up to 15 numbers between 01 and 80, and lighter 100 can be used to generate a selection for the player using 15 look-up instances, displaying on display 106 a sequence such as “01 22 45 13 18 07 77 27 64 34 41 52 68 31 29.”

FIG. 12 shows an exemplary alphanumeric look-up table for use in generating roulette pockets. In this example, a player placing a roulette bet must provide one of 37 or 38 numbered pockets, and lighter 100 can be used to generate a selection for the player using a single look-up instance, displaying on display 106 a selection such as “36-Red.”

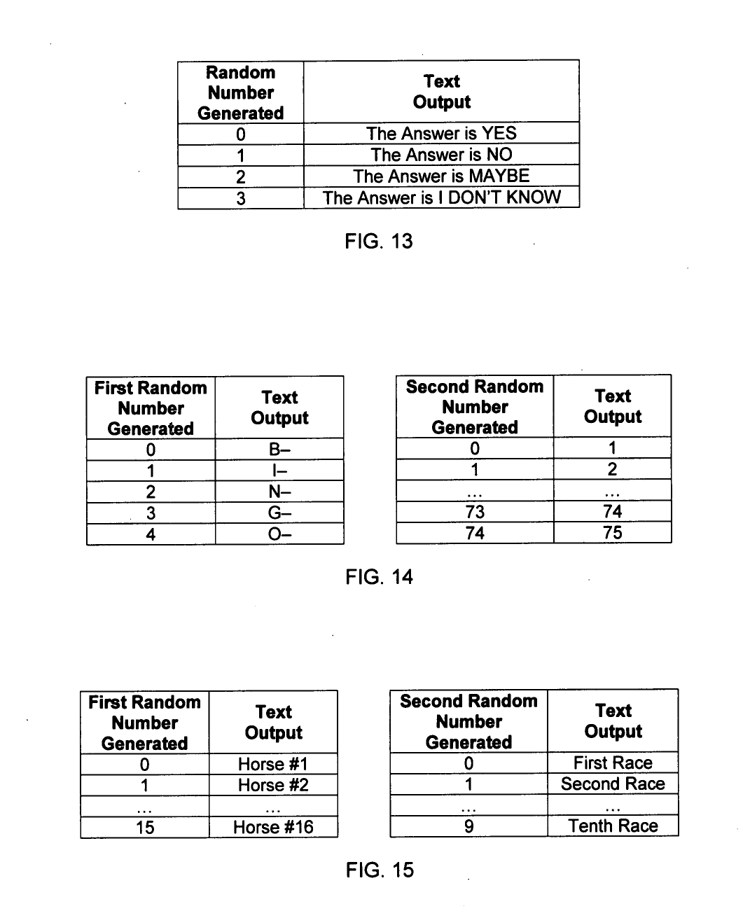

FIG. 13 shows an exemplary alphanumeric look-up table for use in generating “fortune-teller” results. In this example, a user seeks an answer to a “yes-or-no” question, and lighter 100 can be used to generate an answer using a single look-up instance, displaying on display 106 a selection such as “The Answer is NO.”

FIG. 14 shows two exemplary look-up tables for use in generating bingo calls. In this example, lighter 100 can be used to generate bingo calls for a caller who must randomly select several combinations of letters (B, I, N, G, or O) and numbers (e.g., between 1 and 75). Alternatively, in this configuration, lighter 100 could be used for a player who seeks assistance in choosing a bingo card and wishes to choose a card that contains one or more of the bingo calls generated by lighter 100 prior to an actual bingo game. In this scenario, lighter 100 generates a selection using several look-up instances from two different look-up tables, one for the letter portion of the combination and the other for the number portion of the combination, displaying on display 106 a selection such as “B-14 I-22 N-33 G-42 O-6.”

FIG. 15 shows two exemplary look-up tables for use in generating horse race outcomes. In this example, a player placing a bet must provide a horse number for each of a plurality of races, and lighter 100 can be used to generate a selection for the player using a look-up instance from each of two different look-up tables, one for the horse number and one for the race number, displaying on display 106 a selection such as “Horse #7/Third Race.”

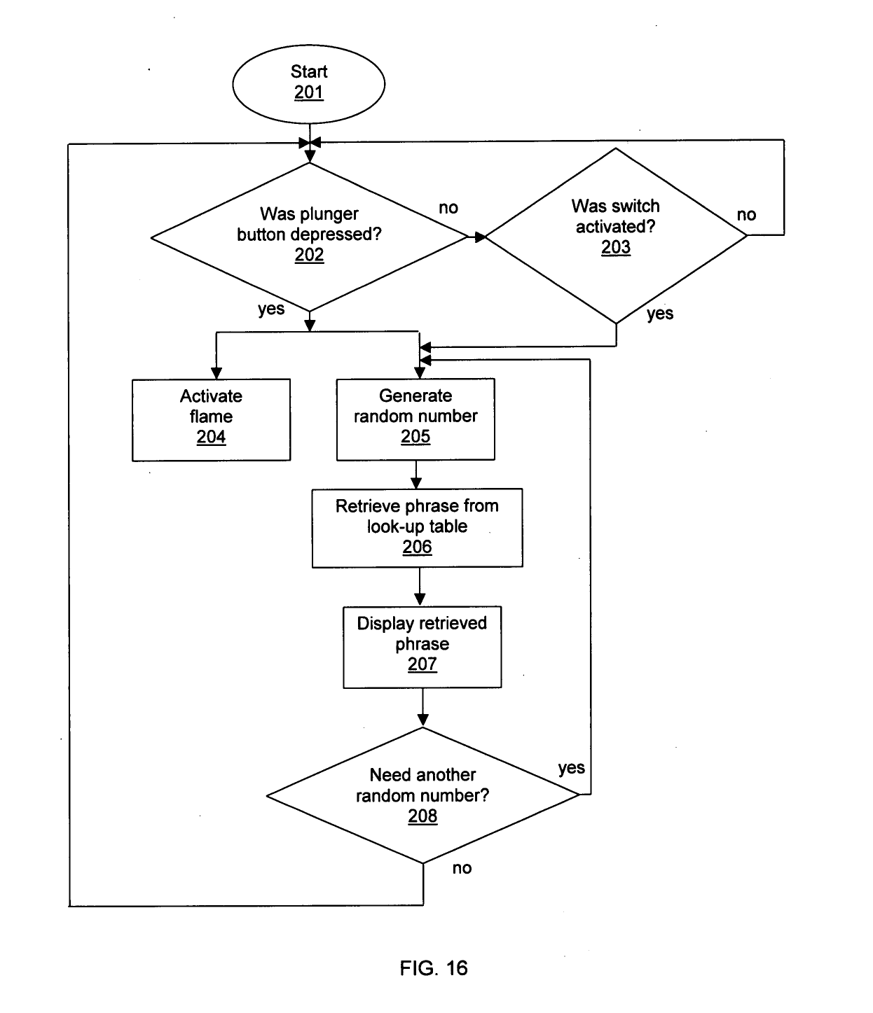

FIG. 16 is a flow chart for an exemplary sequence of operation of random-text display lighter 100. The method begins at step 201. At step 202, a determination is made whether plunger button 102 has been depressed, in which case the method proceeds concurrently (i) to activate the flame functionality at step 204 and (ii) to generate a random number at step 205. If, at step 202, then it is determined that plunger button 102 has not been depressed, the method proceeds to step 203. At step 203, a determination is made whether switch 104 has been activated, in which case the method proceeds to generate a random number at step 205. If, at step 203, it is determined that switch 104 has not been activated, then the method loops back to step 202. Following step 205, a numeric or alphanumeric phrase is retrieved from look-up table 170 at step 206. Next, at step 207, the retrieved phrase is displayed on display 106. Next, a determination is made at step 208 whether another random number is needed, in which case the method loops back to step 205. If, at step 208, it is determined that another random number is not needed, then the method loops back to step 202. It should be understood that, although in the foregoing exemplary method, random numbers are generated and phrases are received one at a time, in alternative embodiments, several random-number generators could generate text simultaneously, in parallel, and several look-up tables could be consulted simultaneously, in parallel, as well.

Portions of the present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

Portions of the present invention can be embodied in the form of methods and apparatuses for practicing those methods. Portions of the present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. Portions of the present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

For purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims are recited in a particular sequence with corresponding labeling, unless the claim recitations otherwise imply a particular sequence for implementing some or all of those elements, those elements are not necessarily intended to be limited to being implemented in that particular sequence.

It will be further understood that various changes in the details, materials, and arrangements of the parts which have been described and illustrated in order to explain the nature of this invention may be made by those skilled in the art without departing from the scope of the invention as expressed in the following claims.

I claim:

1. A lighter comprising:
a housing;
a fuel tank disposed within the housing;
a valve adapted to release fuel from the fuel tank;
a piezoelectric unit adapted to provide a spark to ignite fuel released from the fuel tank;
a display;
circuitry comprising:
(a) one or more random-number generators, each random-number generator adapted to provide a random number from among a plurality of possible numbers; and
(b) one or more look-up tables, each look-up table mapping each of the plurality of possible numbers from one of the random-number generators to a corresponding alphanumeric phrase, wherein the circuitry is adapted to:
(i) generate a random number using one of the random-number generators;
(ii) retrieve, from the one or more look-up tables, an alphanumeric phrase corresponding to the generated random number; and
(iii) display the retrieved alphanumeric phrase on the display; and an activator adapted to:
(i) engage the piezoelectric unit to provide a spark;
(ii) engage the valve to release fuel from the fuel tank; and
(iii) engage the circuitry to display at least one retrieved alphanumeric phrase on the display.

2. The invention of claim 1, wherein:
the one or more random-number generators comprise two or more random-number generators; and
the two or more random-number generators are adapted to generate random numbers in parallel.

3. The invention of claim 1, wherein the one or more look-up tables comprise at least two different look-up tables.

4. The invention of claim 1, wherein the circuitry is adapted to display a plurality of retrieved alphanumeric phrases on the display substantially concurrently.

5. The invention of claim 1, wherein the alphanumeric phrases comprise only numeric phrases.

6. The invention of claim 1, further comprising a switch adapted to engage the circuitry to display at least one retrieved alphanumeric phrase on the display, without (i) engaging the piezoelectric unit to provide a spark or (ii) engaging the valve to release fuel from the fuel tank.

7. The invention of claim 1, wherein the piezoelectric unit is (i) adapted to generate an electric potential and (ii) coupled to the circuitry, such that receipt of the electric potential by the circuitry engages the circuitry to display the at least one retrieved alphanumeric phrase on the display.

8. The invention of claim 1, wherein the piezoelectric unit is (i) adapted to generate an electric potential and (ii) coupled to the circuitry, such that the electric potential provides power to the circuitry.

9. The invention of claim 1, further comprising a battery adapted to provide power to the circuitry, wherein the piezoelectric unit is (i) adapted to generate an electric potential and (ii) coupled to the battery, such that the electric potential recharges the battery.

10. The invention of claim 1, wherein the display is adapted to display the at least one retrieved alphanumeric phrase on the display in scrolling, alternating, or flashing fashion.

11. A method of providing a flame and displaying one or more alphanumeric phrases, the method comprising:
(a) engaging a piezoelectric unit to provide a spark;
(b) releasing fuel from a fuel tank; and
(c) engaging circuitry adapted to:
(i) generate a random number from among a plurality of possible numbers; and
(ii) retrieve, from a look-up table, an alphanumeric phrase corresponding to the generated random number; and
(iii) display the retrieved alphanumeric phrase on a display.

12. The invention of claim 11, further comprising generating a plurality of random numbers in parallel.

13. The invention of claim 11, further comprising displaying a plurality of retrieved alphanumeric phrases on the display substantially concurrently.

14. The invention of claim 11, wherein the alphanumeric phrases comprise only numeric phrases.

15. The invention of claim 11, further comprising displaying the at least one retrieved alphanumeric phrase on the display based on receipt of an electric potential from the piezoelectric unit.

16. The invention of claim 11, further comprising displaying the at least one alphanumeric phrase on the display in scrolling fashion.

17. The invention of claim 11, further comprising providing power to the circuitry using an electric potential received from the piezoelectric unit.

18. The invention of claim 11, further comprising:
providing power to the circuitry using a battery; and
recharging the battery using an electric potential received from the piezoelectric unit.

19. The invention of claim 11, wherein steps (a), (b), and (c) are performed upon activation by a single activator.

20. Apparatus comprising:
a lighter;
circuitry comprising:
(a) one or more random-number generators, each random-number generator adapted to provide a random number from among a plurality of possible numbers; and
(b) one or more look-up tables, each look-up table mapping each of the plurality of possible numbers from one of the random-number generators to a corresponding alphanumeric phrase, wherein the circuitry is adapted to:
(i) generate a random number using one of the random-number generators;
(ii) retrieve, from the one or more look-up tables, an alphanumeric phrase corresponding to the generated random number; and
(iii) display the retrieved alphanumeric phrase on the display; and an activator adapted to:
(i) engage the lighter to provide a flame; and
(ii) engage the circuitry to display at least one retrieved alphanumeric phrase on the display.
